(19) United States
(12) Patent Application Publication
(10) Pub. No.: US 2005/0191391 A1
(43) Pub. Date: Sep. 1, 2005

(54) Method for holding olives fresh

(76) Inventors: James Postma, Chico, CA (US); Merritt C. Erickson, Orland, CA (US)

Correspondence Address: Donald W. Meeker;Patent Agent, 924 East Ocean Front #E, Newport Beach, CA, 92661, US

(21) Appl. No.: 10/789,034

(22) Filed: Feb. 27, 2004

(51) Int. Cl. C12H 1/10

(52) U.S. Cl. 426/321

(57) ABSTRACT

Freshly picked olives are preserved in a holding container by adding Ascorbic Acid and Acetic Acid and water. Ascorbic Acid is also used in soaking olive leaves or parts of the olive tree that makes up Olive Leaf Extract

### BACKGROUND OF THE INVENTION

1. Field of the Invention

The present invention relates to a method for holding olives and specifically to a method for holding olives using corrosive or non-corrosive acid like, acetic acid and ascorbic acid, which produces olives of good color, flavor and texture, to be cured at a later time.

2. Description of the Prior Art

Part of the olive preservation process is to prevent a variety of “browning” processes that occur naturally after the olives are picked. Many of these reactions are oxidations of the plant material by oxygen that is present in that air and dissolved in the solution containing the olives.

For thousands of year's olives were taken off their trees and cured many different ways, and held in water or a salt brine or vinegar solution. More recently, olives have been taken off the trees and put in Acetic Acid or Sodium Benzoate or Lactic Acid or all three to hold them two or more years until they are needed to be cured. After a couple of weeks in the currently used solution the olives turn brown. So when the olive packers want to cure them they add oxygen to them and they turn black. Furthermore, Sodium Benzoate is a toxic substance, which is unhealthy for human consumption.

Using a mechanical harvester bruises or scars the olives and the bruises and scars turn a dark color.

There are olives that are picked for the fresh market, but they are put in a soft cushion container and put in a cold storage and they will keep for about a month. So the consumer will buy the olives and take them home and cure them. This time frame is usually too short for the grower and the consumer.

None of the prior art patents adequately address the problems of holding the olives for a long period (normally about two years) and maintaining the green color of the olives as well as preventing discoloring of the olives from bruises and scarring as well as avoiding the use of toxic substances and replacing them with healthy substances.

U.S. Pat. No. 5,837,304, issued Nov. 17, 1998 to Jepson, shows methods of debittering and coloring black ripe olives, which include the steps of treating the olives with iron solution at elevated temperature, in the absence of oxidizing agents, followed by the step of aerating the solution. The unique coloring method permits a relatively high concentration of lye to be used in the debittering process, which precedes the coloring process, resulting in significant overall timesavings for the combined processes. A three-day debittering and coloring olive process is described which results in consistent, high quality product.

U.S. Pat. No. 4,664,926, issued May, 12, 1987 to Scrimshire, provides a method and apparatus for producing black ripe olives, which comprises immersing the olives in an alkaline solution until the solution penetrates to the pit of the olive to eliminate the bitter principal, and then neutralizing the lye solution by immersing the olives in a carbonic acid solution which is initially supersaturated with carbon dioxide in the absence of air agitation and heat, and thereafter providing a desirable color in the olives by immersion in a ferrous gluconate solution.

U.S. Pat. No. 4,463,023, issued Jul. 31, 1984 to McCorkle, claims a method and apparatus for producing black ripe olives, which comprises periodically introducing an alkaline solution, having a concentration of about 0.45% to 0.7% alkaline for fresh cure olives and 0.9% to 1.2% for storage olives, into a processing tank containing olives to be processed. The olives are agitated in the solution and thereafter the solution is drained from the tank leaving the olives dry in the tank for a period of time before reintroducing the alkaline solution. After repeating the wet-dry cycle a number of times, the blackened ripe olives are rinsed with fresh water. The alkaline solution contains lye (sodium hydroxide) and is retained in a separate storage tank at the completion of each period of wetting the olives. The alkaline solution is periodically strengthened to a desired concentration. The agitation results from bubbling high-pressure air into the processing tank below the olives. The bottom of the tank is corrugated and air is introduced along the valleys of the corrugations to provide improved agitation. Carbon dioxide is added to the rinse water to neutralize the alkalinity of the blackened ripe olives at the end of the process.

U.S. Pat. No. 5,620,726, issued Apr. 15, 1997 to Casamassima, puts forth a process for coloring olives, that uses an aqueous erythrosine solution as the colorant, comprising: desalting the olives in water until the salt content is between 0 and 2%; immersing the olives in an aqueous citric acid solution; eliminating the excess citric acid by washing and drip-drying until the olive pH value is between 4.0 and 4.7; immersing the olives in an aqueous erythrosine solution for a period of time between 20 and 50 minutes at a temperature of 40-75° C., the weight ratio between the erythrosine solution and the olives being 4-6:0.5-2; cooling and washing to remove traces of unfixed colorant; inserting the olives in glass containers which are then immersed in boiling water for 25-30 minutes, after which they are immersed in water at 40-45° C., cooled and packaged.

U.S. Pat. No. 3,480,448, issued Nov. 25, 1969 to Etchells, discloses an improved brine-curing process for olives comprising fermentation controlled by selected microorganisms. Introduction and growth of competing microorganisms is inhibited by the employment of aseptic processing conditions and by the use of a heat-shocking operation. The heat shocking operation is performed on the olives after the lye treatment for debittering but before introducing selected microorganisms.

U.S. Pat. No. 2,582,371, issued Jan. 15, 1952 to Ball, indicates an apparatus and method of processing olives, wherein each olive in a tank gets a uniform stirring movement and complete aeration of the lye or the water once the olives are exposed. The method provides a more uniform lye penetration of the olives, a uniform control of the strength of the lye solution, easy removal of the lye, as well as sterilization and pasteurization of the olives. The apparatus uses minimum space and saves labor, thereby reducing costs.

U.S. Pat. No. 2,464,947 issued Mar. 22, 1949 to Sammis, concerns a method of processing olives that consists of moving a mass of olives along a path and while so in motion alternately bringing the olives in the presence of a sodium hydroxide treating solution and then into the presence of air until the desired effect is attained.

U.S. Pat. No. 3,085,881, issued Apr. 16, 1963 to Ball, illustrates a method of treating ripe olives that uses an alkaline solution, such as sodium hydroxide, color lye treatments and air injection to debitter and remove the cutinal wax from the olive. The olive is treated in a brine of a strength of 1% to 3% before canning, with or without heating, thus the color of the olive may vary from a light brown to a jet black for the finished product.

U.S. Pat. No. 1,264,487, issued Apr. 30, 1918 to Buhles, is for a process of curing olives, which uses a lye solution bath. After the olives have been treated with the lye bath for a considerable length of time they are removed there from and submerged in water or other liquid carrying oxygen. The air or oxygen in the water is replenished so that sufficient oxygen is available to cure and blacken the olives. Once the desired dark brown or black color is attained, the olives are treated with the usual brine solution.

U.S. Pat. No. 1,625,494, issued Apr. 19, 1927 to Olivarius, provides a process of pickling ripe olives, which uses a cutting solution of denatured alcohol in which is dissolved 1% lye. The olives then removed from the cutting solution and are treated in alternately in a weak lye solution and exposed to air until the lye penetrates to the pit of the fruit. The olives are removed from the weak lye solution and washed with water, then brined according to customary practices.

U.S. Pat. No. 2,356,287, issued Aug. 22, 1944 to Van Dellen, shows a method of olive processing that uses salts of manganese as a catalyst for the absorption of oxygen to create an olive with a dark outer surface and a lighter inner meat portion. The olives are first treated in a preliminary fermentation period in salt brine, and then subjected to successive treatments of alkaline solution alternated with air exposure, and adding manganese salt in a proportion of substantially a pound for a thousand gallons of olives to one of the steps of the treatment.

What is needed is a method of holding olives for a long period (normally about two years) and maintaining the green color of the olives as well as preventing discoloring of the olives from bruises and scarring as well as avoiding the use of toxic substances and replacing them with healthy substances.

### SUMMARY OF THE INVENTION

An object of the present invention is to provide a method of adding a solution of Acetic Acid and Ascorbic Acid as a means of holding or preserving olives for a long period (normally about two years) and maintaining the green color of the olives as well as preventing discoloring of the olives from bruises and scarring as well as avoiding the use of toxic substances, such as Sodium Benzoate, and replacing them with a healthy substance, such as Ascorbic Acid combined with the Acetic Acid.

Another object of the method of the present invention is to replace the toxic Sodium Benzoate and Lactic Acid with a healthy substance Ascorbic Acid that adds Vitamin C for health and also acts as an antioxidant for better preserving the olives.

One more object of the method of the present invention is that using Ascorbic Acid with the Olive Leaf Extract, and or powder process also adds Vitamin C to the Olive Leaf Extract and or powder.

One more object of the method of the present invention is that using Ascorbic Acid with water and olives also adds Vitamin C to olive oil making.

In brief, the method of the present invention comprises, after picking the olives and putting them in a bag or any type of container, the first step comprises adding two tablespoons of Ascorbic Acid more or less per gallon of olives. The second step comprises adding water and Acetic Acid at a pH of 3.2 or less, preferably 2.8, to the top of the holding container to stabilize the olives so that no bacteria will grow. Using the Ascorbic Acid performs the same function as Sodium Benzoate and Lactic Acid, but it will keep the olives greener and crisper for a longer period of time.

One of the well-studied properties of Ascorbic Acid is its use as an antioxidant. Ascorbic Acid reacts readily with atmospheric and dissolved oxygen turning it into water. Many fruits and vegetables contain ascorbic acid naturally to protect themselves from oxidation; olives do not. Other preservatives, such as sodium benzoate, BHT, and BHA have this same antioxidant property. Ascorbic acid is used in the present inventive method for its lack of toxicity and commercial acceptance.

An advantage of the method of the present invention is that it holds or preserves the olives and or other fruit and vegetables for a long time (at least two years) and maintains the green color of the olives.

Another advantage of the method of the present invention is that it prevents the discoloring of olives from bruises and scars.

An additional advantage of the method of the present invention is that it replaces a toxic substance with a non-toxic and very healthy substance, which contains Vitamin C so that it adds vitamin C to the olives and an anti-oxidant so that it is more effective as a preservative.

One more advantage of the method of the present invention is that it also adds Vitamin C to Olive Leaf Extract and or powder forming a healthy byproduct.

Yet another advantage of the method of the present invention is that it inhibits the growth of bacteria in or around the olives.

### BEST MODE FOR CARRYING OUT THE INVENTION

A method for holding freshly picked olives to maintain the green color of the olives, prevent discoloration of the olives from bruising and scarring, and add Vitamin C to the olives, comprises adding Acetic Acid and Ascorbic Acid to a holding tank of olives to preserve the olives.

After the olives have been picked and put into a holding container, a first step of the method comprises adding two tablespoons of Ascorbic Acid per gallon of olives to the freshly picked olives in the holding container;

A second step of the method comprises adding a solution of water and Acetic Acid at a pH of at most 3.2, and preferably 2.8, to a top of the holding container.

Ascorbic acid protects the olives from deterioration much better than Sodium Benzoate. This is likely due to a second property of ascorbic acid: its ability to bind to metal ions. In biological settings, iron +2 and +3 ions act as catalysts for a variety of oxidation reactions, including the reaction with atmospheric and dissolved oxygen. By binding to the iron ions, this catalytic activity is stopped and oxidation slows or stops. Other additives, such as disodium EDTA, are used in cosmetics and a few food items for this chelating ability, but ascorbic acid is more soluble, much less toxic, and less expensive than alternatives.

The ascorbic acid is not a significant contribution to the pH adjustment in the preserved olives. It is a weaker acid and present in much smaller quantities than the acetic acid that is used to lower the pH of the preserved olives.

This method produces a pH of less than 4.6 as required by the U.S. Food and Drug Administration (FDA) to be able to sell the olives.

While harvesting the olives they will be put into a bin of water and Ascorbic Acid and not only will the Ascorbic Acid keep the olives greener but it will also prevent the bruises and scars on the olives caused by mechanical harvesting from turning darker and discoloring the olives.

Also, for the first time olives will have Vitamin C in it from the Ascorbic Acid, as tested at the chemistry lab of Chemistry at California State University, Chico. The amount of Vitamin C in the olive flesh and in the surrounding solution was determined using High Performance Liquid Chromatography (HPLC) using reverse-phase and a C-18 column with an ultraviolet detector.

The health aspect of green table olives per se has received scant attention over the years, yet few people realize that the coverage that olive oil has been receiving as a health-boosting product, actually pertains to olives too. It is the high olive oil content in olives, among other factors, that make them so healthy.

This leads into the next health benefit of using Ascorbic Acid in soaking olive leaves or parts of the olive tree that makes up Olive Leaf Extract, and or powder. Now Olive Leaf Extract will have Vitamin C in it also. “Based on Dr. Walker's research as stated in his book, Nature's Antibiotic-Olive Leaf Extract, olive leaf extract appears to be destined to become the most useful, wide spectrum anti-microbial herbal ingredient of the 21st century.

It is understood that the preceding description is given merely by way of illustration and not in limitation of the invention and that various modifications may be made thereto without departing from the spirit of the invention as claimed.

1. A method for holding freshly picked olives to maintain the green color of the olives, prevent discoloration of the olives from bruising and scarring, and add Vitamin C to the olives, the method comprising:
A first step of adding a quantity of Ascorbic Acid to freshly picked olives in a container;
A second step comprising adding a solution of water and Acetic Acid at a pH of at most 3.2 to a top of the container.

2. The method of claim 1 preferably wherein the solution of water and Acetic Acid has a pH of 2.8.

3. The method of claim 1 wherein the quantity of Ascorbic Acid is two tablespoons of Ascorbic Acid per gallon of olives.

4. The method of claim 1 further comprising the step of using Ascorbic Acid in soaking olive leaves or parts of the olive tree that makes up olive leaf extract.
